(19) United States
(12) Patent Application Publication
(10) Pub. No.: US 2008/0151402 A1
(43) Pub. Date: Jun. 26, 2008

(54) COLOR WHEEL

(75) Inventor: Pi-Tsung Hsu, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/761,163

(22) Filed: Jun. 11, 2007

(30) Foreign Application Priority Data
Dec. 21, 2006 (CN) 200610201356.7

(51) Int. Cl. G02B 5/22

(52) U.S. Cl. 359/892; 359/889

(57) ABSTRACT

An exemplary color wheel includes a motor, a locking member, an annular color filter assembly, and an elastic member. The motor includes a rotating shaft, a stop portion, and a lock-receiving portion. The stop portion is fixed to the rotating shaft, and the lock-receiving portion is defined in the rotating shaft. The locking member is lockably received by the lock-receiving portion. The color filter assembly is disposed on the stop portion. The elastic member is interposed between the color filter assembly and the locking member and is compressed therebetween, so as to push the color filter assembly against the stop portion.

### BACKGROUND

1. Technical Field

The present invention relates to a color wheel and, particularly, to a color wheel for use in projection technology.

2. Description of Related Art

Color composition in digital light processing (DLP) projectors can be accomplished, for example, by two different methods: single-panel and three-panel. In the former, each projector is equipped with one digital micro-mirror device (DMD); white light from a light source is dispersed into red (R), green (G) and blue (B) lights, sequentially; the DMD switches between the R, G and B lights to produce R, G and B images, in sequence; and a color composition of the R, G and B images is formed by viewers due to an afterimage effect. In the latter, three DMDs respectively dedicated to R, G and B lights are employed in one projector; R, G and B images are produced in parallel; and a color composition is accomplished by projecting the R, G and B images at/onto a screen, or the like.

Projectors with a single DMD tend to be small in size and low in price. Thus, these projectors are very popular. In these projectors, a color wheel is preferably used as a sequential dispersing device to disperse white light into R, G and B lights, in sequence. A typical color wheel includes a motor and a color filter assembly fixed on the motor. The color filter assembly includes a disk-shaped carrier and a plurality of pie-slice-shaped color filters, annularly arranged and disposed on the carrier. When the color filter assembly is driven to rotate by the motor, color filters respectively dedicated for exclusively transmitting, for example, R, G and B lights filter white light, in turn. Thus, R, G and B lights are produced, in sequence.

Most color wheels join the color filter assembly and the motor using hot-curable adhesive. These color wheels need to undergo a curing process for curing the adhesive when they are being manufactured. Motors in these color wheels may be easily damaged in the curing process since most of the motors cannot withstand the curing temperature of the curing process. Additionally, reworkablity of these color wheels is less than optimal, since components of these color wheels are inseparable and workable components in a partially damaged color wheel cannot be reused.

Therefore, it is desirable to provide a color wheel which can overcome the above-mentioned problems.

### SUMMARY

In a present embodiment, a color wheel includes a motor, a locking member, a color filter assembly, and an elastic member. The motor includes a rotating shaft, a stop portion, and a lock-receiving portion. The stop portion is fixed to the rotating shaft, and the lock-receiving portion is defined in the rotating shaft. The locking member is accommodated and locked in the lock-receiving portion. The color filter assembly is disposed on the stop portion. The elastic member is interposed between the color filter assembly and the locking member and is compressed therebetween to push the color filter assembly against the stop portion.

### BRIEF DESCRIPTION OF THE DRAWINGS

Many aspects of the present color wheel should be better understood with reference to the following drawings. The components in the drawings are not necessarily drawn to scale, the emphasis instead being placed upon clearly illustrating the principles of the present color wheel. Moreover, in the drawings, like reference numerals designate corresponding parts throughout the several views.

FIG. 1 is an isometric, exploded view of a color wheel, according to a first embodiment;

FIG. 2 is a plane, assembled view of the color wheel, according to the first embodiment;

FIG. 3 is an isometric, exploded view of a color wheel, according to a second embodiment;

FIG. 4 is a plane, assembled view of the color wheel, according to the second embodiment; and

FIG. 5 is an isometric, exploded view of a color wheel, according to a third embodiment.

### DETAILED DESCRIPTION OF THE EMBODIMENTS

Embodiments of the present color wheel will now be described in detail with reference to the drawings.

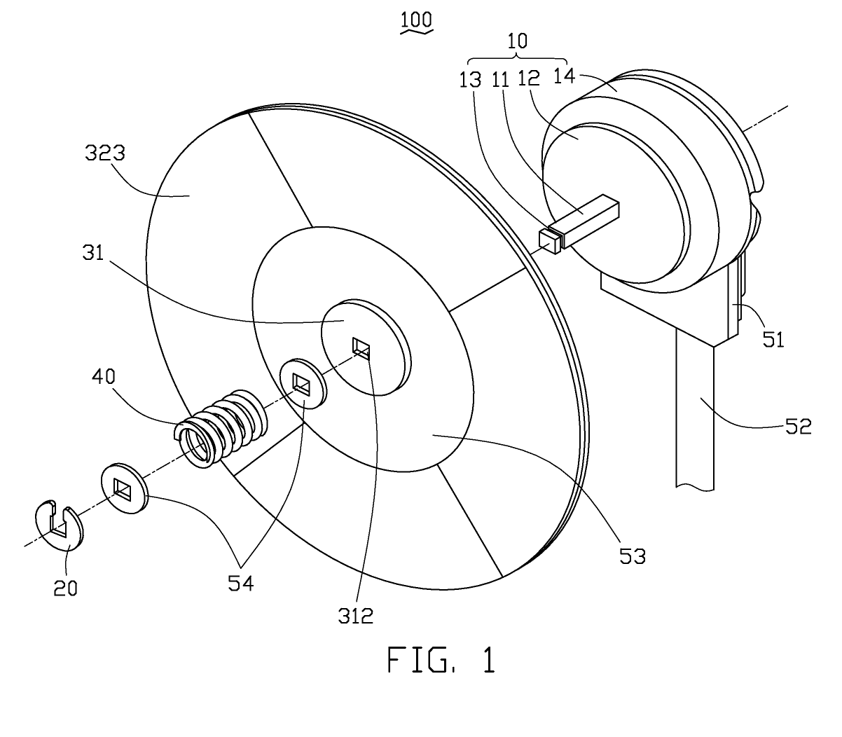

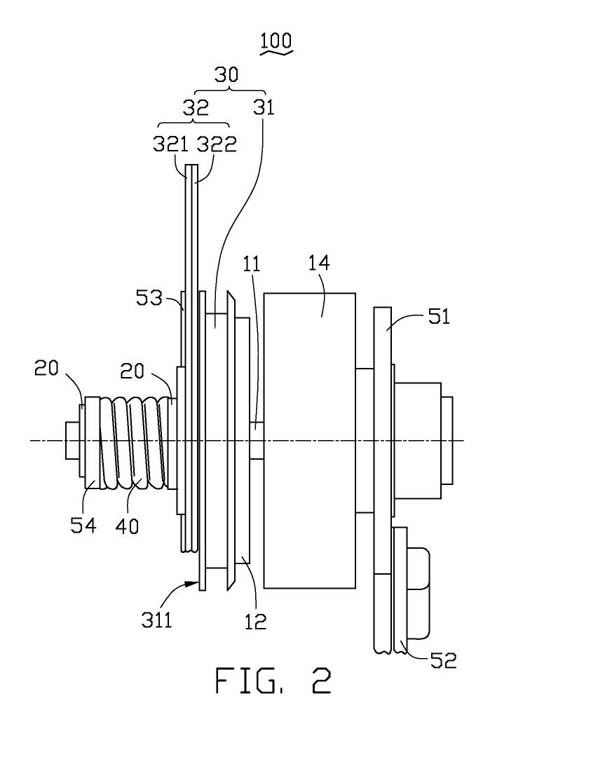

Referring to FIG. 1 and FIG. 2, a color wheel 100, according to a first embodiment, includes a motor 10, a locking member 20, a color filter assembly 30, and an elastic member 40. The motor 10 includes a rotating shaft 11, a stop portion 12, and a lock-receiving portion 13. The stop portion 12 is fixed to the rotating shaft 11, and the lock-receiving portion 13 is defined in the rotating shaft 11, near a distal end thereof. The locking member 20 is accommodated and slidably locked in the groove-shaped lock-receiving portion 13. In particular, the locking member 20 is usefully a retaining ring configured (i.e., structured and arranged) for fitting into the groove shape of the lock-receiving portion 13. The retaining ring can be, for example, a C-shaped ring, an E-shaped ring, or a U-shaped ring, etc., depending on a corresponding shape of the receiving groove. The color filter assembly 30 is disposed on the stop portion 12. The elastic member 40 is interposed between the color filter assembly 30 and the locking member 20 and is compressed therebetween to push the color filter assembly 30 against the stop portion 12. In this way the color filter assembly 30 is fixed on the motor 10.

The motor 10 is configured for driving the color filter assembly 30 to rotate. In addition to the rotating shaft 11, the stop portion 12, and the lock-receiving portion 13, the motor 10 further includes a main body 14 employing electromagnetic members (not shown) therein for driving the rotating shaft 11 to rotate. The rotating shaft 11 rotatably protrudes outwardly from the main body 14, and the stop portion 12 and the lock-receiving portion 13 are arranged, in this order, from a near-end to a far-end of the main body 14. The distance between the stop portion 12 and the lock-receiving portion 13 is shorter than the natural length of the elastic member 40. Thus, in order to fit/attach the locking member 20 within the lock-receiving portion 13, the elastic member 40, cooperating with the stop portion 12, must consequentially be compressed. Thus, upon assembly, the elastic member 40 is loaded in compression, providing a constant spring force against both the locking member 20 and the stop portion 13. The elastic member 40 is, advantageously, a spring (e.g., a coil spring) capable of surrounding the rotating shaft 11 (e.g., slidable therealong), but it could alternatively take the form of, e.g., an elastomeric sleeve. Additionally, two spacers 54 are employed at the two ends of the spring 40 and are configured for effectively enlarging the contact surface, respectively, between the locking member 20 and the spring 40 and between the color filter assembly 30 and the spring 40.

The rotating shaft 11 is, advantageously, an axially symmetric shaft and can be a non-circular shaft, e.g., a square (as shown) or regularly polygonal shaft, or a circular shaft. The stop portion 12 can beneficially extend radially from the rotating shaft 11 and coaxially therewith, e.g., a disk integrally formed with the rotating shaft 11 or, potentially, separately formed yet welded/soldered thereto (i.e., either way, directly extending from the rotating shaft 11). Alternatively, the stop portion can be in the form of a plurality of pins annularly distributed around and extending, e.g., radially, from the rotating shaft 11. The rotating shaft 11 and the stop portion 12, thus structured, are rotationally symmetric with respect to the rotating axis of the motor 10. Thus, both of them can be driven to rotate without centrifugal effort. In this illustrated embodiment, the main body 14 is fixed in a holding socket 51 and is electrically connected to a control circuit (not shown) via wires 52; the rotating shaft 11 is a non-circular shaft, i.e., square shaft; and the stop portion 12 is a disk radially, coaxially, and integrally fixed with the rotating shaft 11.

The color filter assembly 30 includes a disk-shaped carrier 31 and a plurality of pie-slice-shaped color filters 32, annularly arranged and attached to the carrier 31. The carrier 31 is, advantageously, a metal ring having an attachable surface 311 to which the color filters 32 can be joined or otherwise linked. Three color filters 32 respectively dedicated to exclusively transmitting green (G), blue (B), and red (R) lights and a fourth clear filter 32 for transmission of white light are employed in the color filter assembly 30 of this illustrated embodiment. Each color filter 32 includes a transparent substrate 321 such as transparent glass. Three of the transparent substrates 321 are respectively coated with R, G, or B light filter films 322. The fourth substrate 321 is not coated, thereby allowing white light to pass therethrough. The color filters 32 have a radius larger than that of the carrier 31, and thus the color filters 32 attached/mounted to the attachable surface 311 forms an annular light-transmitting section 323, each configured for filtering light to allow passage of a given color.

According to the shape of the rotating shaft 11, the carrier 31 has a non-circular central hole 312 matching with the non-circular shaft. In this illustrated embodiment, the non-circular central hole 312 is a square hole configured for fittingly receiving a square rotating shaft in a manner that, for one, minimizes vibration therebetween. The color filter assembly 30 is disposed on the stop portion 12 with the non-circular shaft inserting through the non-circular hole 312. The non-circular hole 312 and the rotating shaft 11, thus structured, can prevent the color filter assembly 30 from rotating relative to the rotating shaft 11 (i.e., the mating square shape of each acts an anti-rotation lock therebetween). Thus, the color filter assembly 30 is fixed on the motor 10 more firmly.

The color filters 32 are attached to the attachable surface 311, usefully, using a hot-curable adhesive. However, such an adhesive is readily deteriorated in an excessively hot environment. But, for filtering light from a light source (not shown), the attachable surface 311 must set directly facing the light source. Thus, the adhesive may be directly impinged by light and is readily heated thereby. This heating may result in deterioration of the adhesive. In the color wheel 100, a light-reflective film 53 is employed for protecting the adhesive from being directly impinged upon by the light. The light-reflective film 53 is positioned on the color filters 32 and is sized so as to exactly cover and thus protect the carrier 31.

The color wheel 100 maintains assembly of the motor 10 and the color filter assembly 30 using mechanical force (e.g., elastic force), instead of hot-curable adhesive, and can be manufactured without the curing process, which could otherwise disable the motor 10. Thus, the motor 10 is shielded/prevented from damage during manufacture. Additionally, the motor 10 and the color filter assembly 30, thus combined, are separable, if needed. Thus, potential reworkablity/repair of the color wheel 100 is improved.

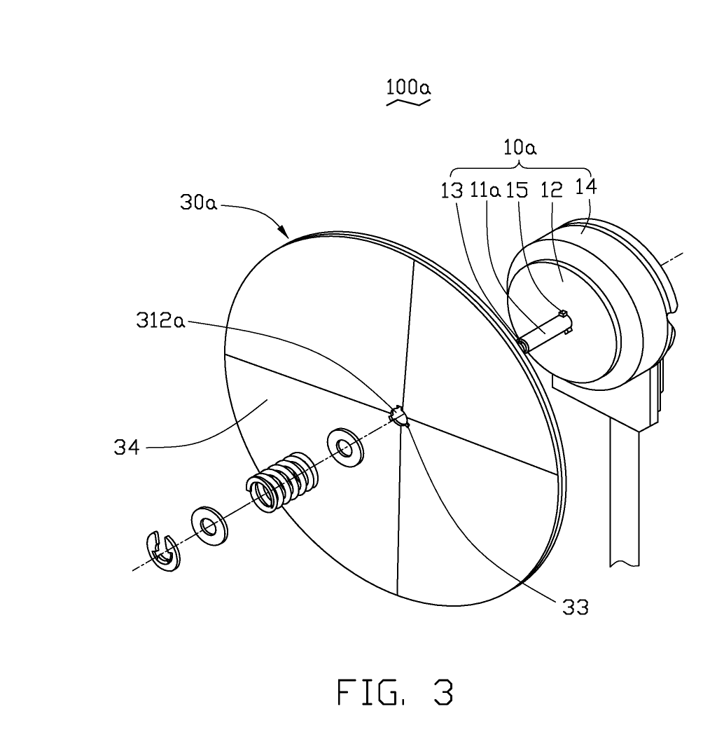

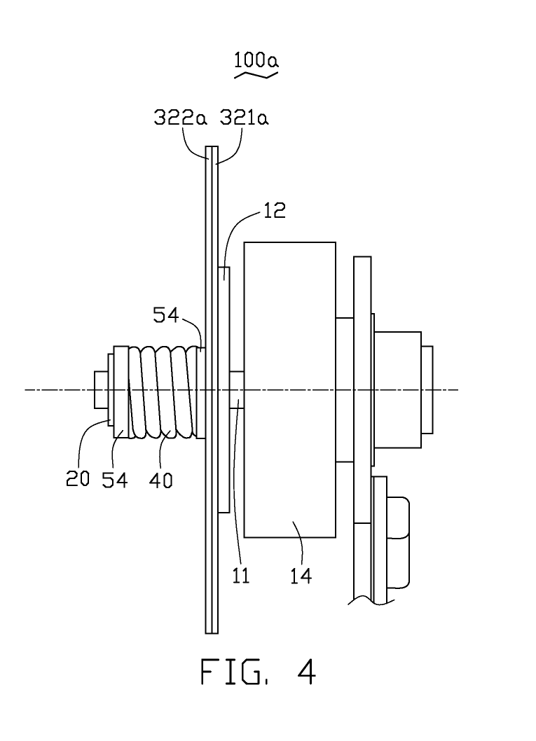

Referring to FIG. 3 and FIG. 4, a color wheel 100a, according to a second embodiment, is essentially similar to the color wheel 100 except with respect to the motor 10a and the color filter assembly 30a.

The rotating shaft 11a of the motor 10a in this embodiment is a circular shaft. In accordance to the shape of the rotating shaft 11a, the color filter assembly 30a has a circular central hole 312a sized to allow the circular shaft to be matingly/fittingly inserted therethrough. In order to prevent the color filter assembly 30a from rotating relative to the rotating shaft 11a, the motor 10a further includes an anti-rotating portion 15 placed between the stop portion 12 and the lock-receiving portion 13, and the color filter assembly 30a accordingly further includes a catching portion 33 matching with the anti-rotating portion 15.

In this illustrated embodiment, the anti-rotating portion 15 is at least one radial projection projecting from the circular shaft (e.g., a pin or block). Meanwhile, each catching portion 33 is in the form of at least one radial gap defined around the circular central hole 312a, each radial gap being configured for matingly receiving a corresponding radial projection of the anti-rotating portion 15. Specifically, the anti-rotating portion 15 can have, as per the illustrated example, three radial insert blocks distributed equally around the rotating shaft 11a, and the catching portion 33 includes three radial gaps defined around the circular central hole 312a, in a similarly equally spaced way.

The color filter assembly 30a includes a disk-shaped transparent substrate 321a. One surface of the transparent substrate 321a is divided into a plurality of pie-shaped areas 34. The pie-shaped areas 34 are coated with different colored light filter films 322a, each respectively dedicated to exclusively transmitting a different color light. The color filter assembly 30a is not assembled using a hot-curable adhesive (i.e., achieved by coating, instead), and thus the light-reflective film 53 is saved/not employed in this illustrated embodiment.

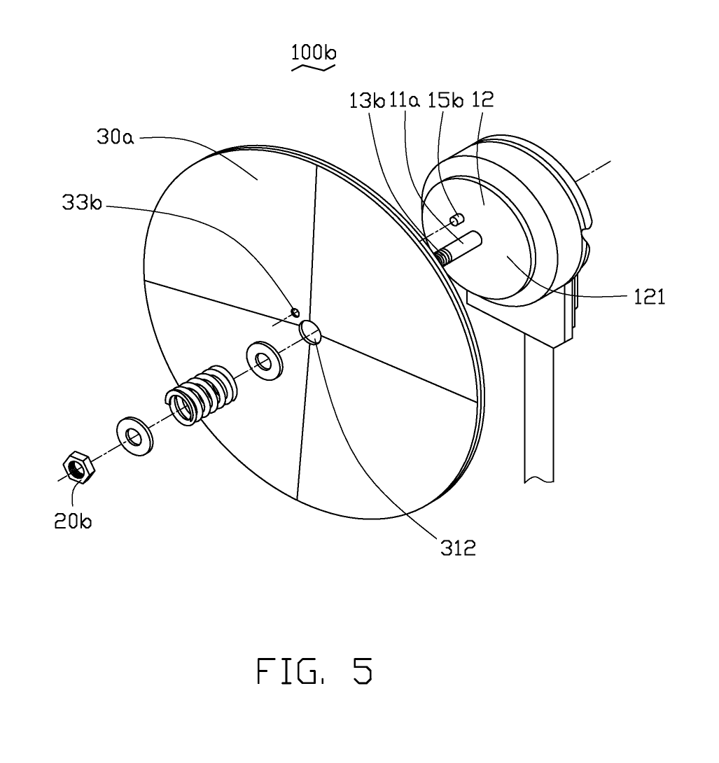

Referring to FIG. 5, a color wheel 100b, according to a third embodiment, is essentially similar to the color wheel 100a, except with respect to the lock-receiving portion 13b, the anti-rotating portion 15b, the catching portion 33b, and the locking member 20b.

The stop portion 12 has a contact surface 121 in contact with the color filter assembly 30a. The anti-rotating portion 15b includes at least one longitudinal projection, e.g., pin, projecting from the contact surface 121. The catching portion 33b incorporates at least one recess or hole defined in a surface of the color filter assembly 30a, which is in contact with the contact surface 121 and which is configured for matingly receiving therein a corresponding projection of the anti-rotating portion 15b. The color filter assembly 30a is disposed on the stop portion 12 with the at least one longitudinal projection inserted into the at least one recess or hole. In this illustrated embodiment, the anti-rotating portion 15b is a pin integrally formed on the contact surface 121, and the catching portion 33b is a through hole having a diameter equal to that of the pin.

It should be noted that the anti-rotating portion 15b also could be at least one recess or hole defined in the contact surface 121, and accordingly, the catching portion 33b would be at least one projection formed on the surface of the color filter assembly 30a, in contact with the contact surface 121.

The lock-receiving portion 13b is a threaded section defined at the rotating shaft 11a, and accordingly, the locking member 20b, in this illustrated embodiment, is a nut coupling with the thread section.

It is to be understood that elements from the three embodiments, to the degree practical, could potentially be combined and/or interchanged. Further, where a mating and/or fitting match between parts is prescribed, it is to be understood that such a fit should permit sliding therebetween to allow reasonably easy assembly/disassembly yet should be tight enough to otherwise minimize any potential lateral movement/vibration therebetween.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A color wheel comprising:
a motor including:
a rotating shaft;
a stop portion fixed to the rotating shaft; and
a lock-receiving portion defined in the rotating shaft;
a locking member lockingly received by the lock-receiving portion;
a color filter assembly disposed on the stop portion; and
an elastic member interposed between the color filter assembly and the locking member, the elastic member thereby being configured to push the color filter assembly against the stop portion.

2. The color wheel as claimed in the claim 1, wherein the motor further comprises a main body, the rotating shaft rotatably protruding outwardly from the main body, the stop portion and the lock-receiving portion being arranged, in order, from a near-end to a far-end of the main body.

3. The color wheel as claimed in the claim 1, wherein the distance between the stop portion and the lock-receiving portion is shorter than the natural length of the elastic member.

4. The color wheel as claimed in the claim 1, wherein the rotating shaft is an axially symmetric shaft.

5. The color wheel as claimed in the claim 4, wherein the rotating shaft is a non-circular shaft, the color filter assembly defines a non-circular central hole configured for insertably receiving the rotating shaft therethrough in such a manner to prevent the color filter assembly from rotating relative to the rotating shaft.

6. The color wheel as claimed in the claim 4, wherein the rotating shaft is a circular shaft, the color filter assembly defines a circular central hole configured for matingly insertably receiving the rotating shaft therethrough.

7. The color wheel as claimed in the claim 6, wherein the motor further comprises an anti-rotating portion positioned between the stop portion and the lock-receiving portion, the color filter assembly further comprising a catching portion, the catching portion matingly receiving the anti-rotating portion.

8. The color wheel as claimed in the claim 7, wherein the anti-rotating portion includes at least one radial projection projecting from the rotating shaft, the catching portion comprising at least one radial gap defined around the circular central hole, the catching portion being configured for catching the anti-rotating portion so as to prevent the color filter assembly from rotating relative to the rotating shaft.

9. The color wheel as claimed in the claim 7, wherein the stop portion includes a contact surface in contact with the color filter assembly, the anti-rotating portion incorporating at least one longitudinal projection projecting from the contact surface, the catching portion including at least one recess defined in a surface of the color filter assembly, the surface of the color filter assembly being in contact with the contact surface of the stop portion, the catching portion being configured for catching the anti-rotating portion so as to prevent the color filter assembly from rotating relative to the rotating shaft.

10. The color wheel as claimed in the claim 7, wherein the stop portion includes a contact surface in contact with the color filter assembly, the anti-rotating portion providing at least one longitudinal projection projecting from the contact surface, the catching portion including at least one hole defined in a surface of the color filter assembly, the surface of the color filter assembly being in contact with the contact surface of the stop portion, the catching portion being configured for catching the anti-rotating portion to prevent the color filter assembly from rotating relative to the rotating shaft.

11. The color wheel as claimed in the claim 7, wherein the stop portion includes a contact surface in contact with the color filter assembly, the anti-rotating portion including at least one recess defined in the contact surface; the catching portion providing at least one longitudinal projection projecting from a surface of the color filter assembly, the surface of the color filter assembly being in contact with the contact surface, the catching portion being configured for catching the anti-rotating portion to prevent the color filter assembly from rotating relative to the rotating shaft.

12. The color wheel as claimed in the claim 7, wherein the stop portion includes a contact surface in contact with the color filter assembly, the anti-rotating portion including at least one hole defined in the contact surface; the catching portion providing at least one longitudinal projection projecting from a surface of the color filter assembly, the surface of the color filter assembly being in contact with the contact surface, the catching portion being configured to prevent the color filter assembly from rotating relative to the rotating shaft.

13. The color wheel as claimed in the claim 1, wherein the stop portion extends radially from the rotating shaft and is coaxial therewith.

14. The color wheel as claimed in the claim 1, wherein the lock-receiving portion is a receiving groove defined in the rotating shaft, and the locking member is a retaining ring matingly receivable in the receiving groove.

15. The color wheel as claimed in the claim 1, wherein the lock-receiving portion is a thread section defined on the rotating shaft, and the locking member is a nut coupling with the thread section.

16. The color wheel as claimed in the claim 1, wherein the color filter assembly comprises a disk-shaped carrier and a plurality of pie-shaped color filters annularly arranged and attached to the carrier.

17. The color wheel as claimed in the claim 13, wherein the color filters are attached to the carrier using a hot-curable adhesive, the color wheel further comprising a light-reflective film positioned on the color filter and sized so as to cover the carrier.

18. The color wheel as claimed in the claim 1, wherein the color filter assembly comprises a disk-shaped transparent substrate, the substrate being divided into a plurality of pie-shaped areas being respectively coated with a different light filter film, each respective light filter film being dedicated for exclusively transmitting a different color light.

19. The color wheel as claimed in the claim 1, wherein the elastic member is a spring.
